(19) United States
(12) Patent Application Publication
(10) Pub. No.: US 2016/0312977 A1
(43) Pub. Date: Oct. 27, 2016

(54) TOTAL INTERNAL REFLECTION LENS WITH STEP-SHAPED FRONT SURFACE AND CENTRAL CONVEX REGION

(71) Applicant: LedEngin, Inc., San Jose, CA (US)

(72) Inventors: Wu Jiang, Sunnyvale, CA (US); Debo Adebiyi, Fremont, CA (US)

(21) Appl. No.: 14/692,678

(22) Filed: Apr. 21, 2015

(51) Int. Cl. F21V 5/04

(52) U.S. Cl. CPC F21V 5/045; F21Y 2101/02

(57) ABSTRACT

A total internal reflection (TIR) lens can have a back surface tapered to provide total internal reflection of light toward the front surface. The front surface can have a stepped shape defining a cavity that extends into the lens body, with a width of the cavity increasing toward a front side of the lens. The front surface can further have a convex central surface segment that extends from the front surface within a central portion of the cavity. A peripheral cover member can be formed integrally with the lens body, with a front surface extending laterally outward from an outer edge of the front surface of the lens body and a back surface extending laterally outward from an outer edge of the back surface of the lens body.

### BACKGROUND

The present disclosure relates generally to lenses for LED-based lighting devices and in particular to a total internal reflection lens to provide a narrow beam distribution.

Incandescent lamps have long been recognized as relatively inefficient light sources, and there is increasing interest in replacing them with more efficient alternatives, such as lamps that incorporate light-emitting diodes (LEDs), which can produce light at much higher efficiency. However, the LED is a very different device from traditional filament-based light sources, and much work is needed to produce LED lamps that are acceptable to consumers as substitutes for existing types of lamps.

For example, one standard class of lamps is the “PAR” (parabolic aluminized reflector) type, which are available in an array of sizes (e.g., PAR-30 for a lamp with 95 mm diameter). These lamps are often used in lighting applications where directional lighting is desired, such as recessed ceiling light fixtures, stage lighting, and the like.

LED-based replacements for such lamps have been created, but these are often unsatisfactory for various reasons. More satisfactory lamps are still desired.

### SUMMARY

Certain embodiments of the present invention relate to a lens that can be used in an LED-based PAR replacement lamp. The lens is designed to provide total internal reflection from an LED-based emitter to a front surface of the lens, forming a directed beam with comparable characteristics to existing PAR lamps. The lens can also provide color mixing for light from multiple LEDs in the emitter, which can create a less monochromatic and harsh light.

In some embodiments, the lens can have a body with a back surface tapered (e.g., conforming to a conic equation) to provide total internal reflection and color mixing. The front surface of the lens can be shaped to facilitate beam shaping, additional color mixing, and/or esthetic improvements in the appearance of the lamp or the output light. For example, the front surface can define a cavity with a step-shaped wall that extends into the lens body. The step-shaped wall can help to reduce glare from the front surface. In the center, within the cavity, a central convex portion can be formed, which can help to reduce a central “hot spot” where the light appears extra-bright when the lamp is illuminated.

The lens can also include a peripheral cover member that can be formed integrally with the lens body. The cover member can extend radially outward from a peripheral edge of the front surface. In some embodiments, the peripheral cover member can incorporate alignment and/or retention structures to facilitate mounting of the lens into a lamp. Such structures can be on a back surface of the peripheral cover member so that they are not visible when the lamp is installed in a light fixture. In some embodiments, the peripheral cover member can extend to the full width of the lamp, so that when an assembled lamp is viewed from the front, only the peripheral cover member is visible. This can improve the esthetic appearance of the lamp regardless of whether it is or is not generating light.

Some embodiments relate to a lens that can be made, e.g., of PMMA or other optically transparent materials. The lens can include a lens body having a back surface and a front surface. The back surface of the lens body can have a tapered shape that is symmetric about an optical axis; this tapered shape can provide total internal reflection to direct light from a light source position near a central portion of the back surface toward the front surface. A central portion of the back surface can form a rear cavity to receive a light emitting device, and a planar surface portion can extend around a periphery of the rear cavity. The front surface of the lens body can have a stepped shape symmetric about the optical axis, defining a cavity that extends into the lens body, with a width of the cavity increasing toward a front side of the lens. The front surface can further have a convex central surface segment that extends from the front surface within a central portion of the cavity. A peripheral cover member can be formed integrally with the lens body. A front surface of the peripheral cover member can extend laterally from an outer edge of the front surface of the lens body, and a back surface of the peripheral cover member can extend laterally from an outer edge of the back surface of the lens body. For esthetic effect, an outer portion of the peripheral cover member can curve away from a plane defined by an outer portion of the front surface of the lens body.

The back surface of the peripheral cover member can incorporate one or more alignment structures (e.g., alignment tabs, alignment or mounting posts, receptacles for alignment tabs and/or alignment or mounting posts) that can facilitate assembly of the lens into a lamp.

In some embodiments, the stepped shape of the front surface of the lens body can include alternating lateral and longitudinal surface segments, each lateral surface segment being normal to the optical axis and each longitudinal surface segment being substantially parallel to the optical axis. The convex central portion of the front surface of the lens body can extend forward from a central lateral surface segment and can include a substantially cylindrical segment and a convex forward surface segment. Portions of the front surface of the lens body can be patterned with microlenses (e.g., convex hexagonal surface segments). For instance, the lateral surface segments and the convex forward surface segment can be patterned with microlenses.

Various surfaces of the lens can be frosted if desired. For example, the front surface of the peripheral cover member can be frosted. Additionally or instead, portions of the front surface of the lens body can be frosted. Frosting and microlenses can be applied together to the same surface or surface segment if desired. Other surfaces or surface segments can be smooth (e.g., the back surface of the lens body and longitudinal surface segments of the front surface).

In some embodiments, the lens can be incorporated into a lamp with a light source (e.g., an emitter with multiple LEDs of different colors on a single substrate) and a frame that holds the light source in alignment with the lens. The peripheral cover member of the lens can have an outer radius at least equal to an outer radius of the frame, so that when the lamp is seen from the front, only the lens is visible.

The following detailed description together with the accompanying drawings will provide a better understanding of the nature and advantages of the present invention.

### BRIEF DESCRIPTION OF THE DRAWINGS

FIG. 1 shows a front perspective view of a total internal reflection (TIR) lens according to an embodiment of the present invention.

FIG. 2 shows a front perspective view of a TIR lens with an integrated peripheral cover member according to an embodiment of the present invention.

FIG. 3 shows a back perspective view of a TIR lens with an integrated peripheral cover member according to an embodiment of the present invention.

FIG. 4 shows a side view of a TIR lens with an integrated peripheral cover member according to an embodiment of the present invention.

FIG. 5 shows a cross-section side view of a TIR lens with an integrated peripheral cover member according to an embodiment of the present invention.

FIG. 6 shows a front view of a TIR lens with an integrated peripheral cover member according to an embodiment of the present invention.

FIG. 7 shows a back view of a TIR lens with an integrated peripheral cover member according to an embodiment of the present invention.

FIGS. 8A and 8B show a front view and a side view of a single microlens according to an embodiment of the present invention.

FIG. 9 shows a side view of a lamp incorporating a TIR lens according to an embodiment of the present invention.

FIG. 10 shows a perspective view of a lamp incorporating a TIR lens according to an embodiment of the present invention.

FIG. 11 shows a simplified cross-sectional view of a lamp incorporating a TIR lens according to an embodiment of the present invention.

### DETAILED DESCRIPTION

Certain embodiments of the present invention relate to a lens that can be used in an LED-based PAR replacement lamp. The lens is designed to provide total internal reflection from an LED-based emitter to a front surface of the lens, forming a directed beam with comparable characteristics to existing PAR lamps. The lens can also provide color mixing for light from multiple LEDs in the emitter, which can create a less monochromatic and harsh light.

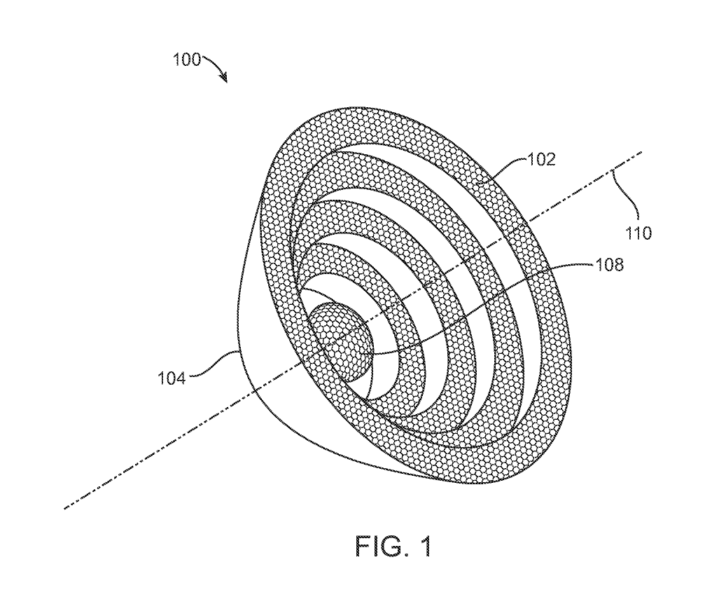

FIG. 1 shows a front perspective view of a total internal reflection (TIR) lens 100 according to an embodiment of the present invention. TIR lens 100 can be symmetric about an optical axis 110 (dashed line shown for reference) and can have a front surface 102 and a back surface 104. In operation, an LED-based emitter can be placed at or near the center of back surface 104, and light can be directed by TIR lens 100 toward front surface 102 to form a beam. Back surface 104 can have a tapered (e.g., conic) shape to facilitate total internal reflection. Front surface 102 can have a stepped shape, examples of which are described below. Front surface 102 can also include a convex central segment 108. In some embodiments, TIR lens 100 can be made from a molded optically transparent material such as poly(methylmethacrylate) (PMMA), other optically transparent plastics, or other optically transparent materials as desired.

The dimensions of TIR lens 100 can be selected as desired. In one embodiment suitable for use in a PAR-30 lamp replacement, TIR lens 100 can have a thickness (dimension along the optical axis) of about 29.3 mm and an outer diameter (at front surface 102) of about 60.0 mm.

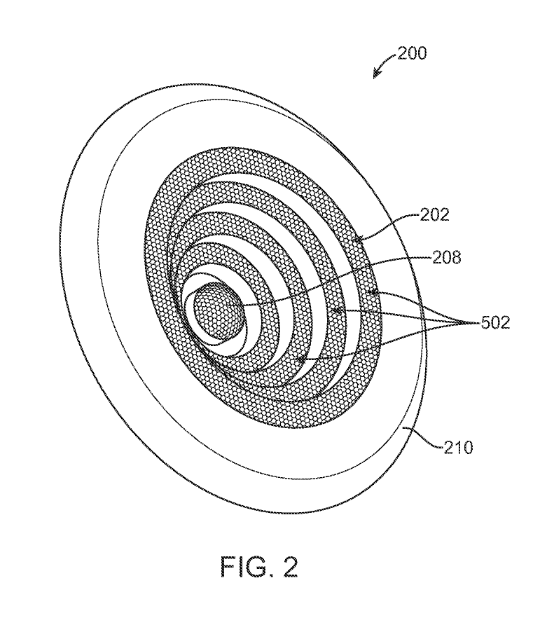

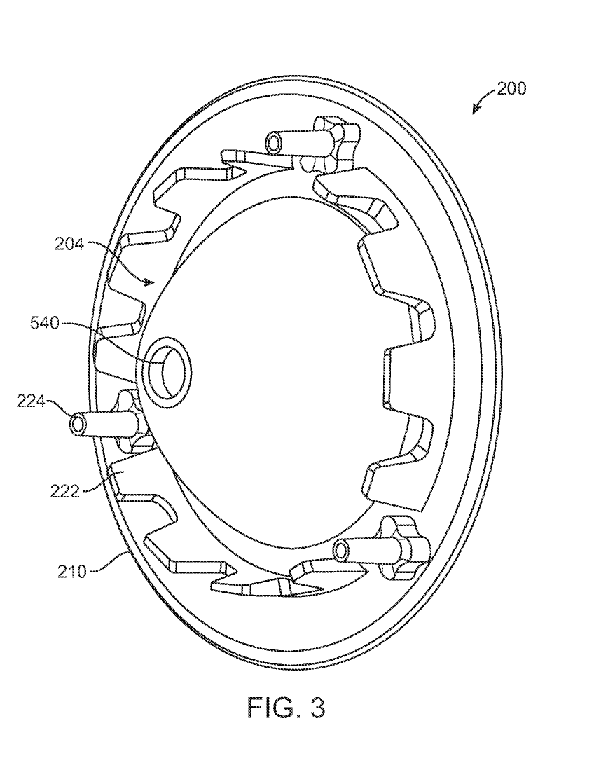

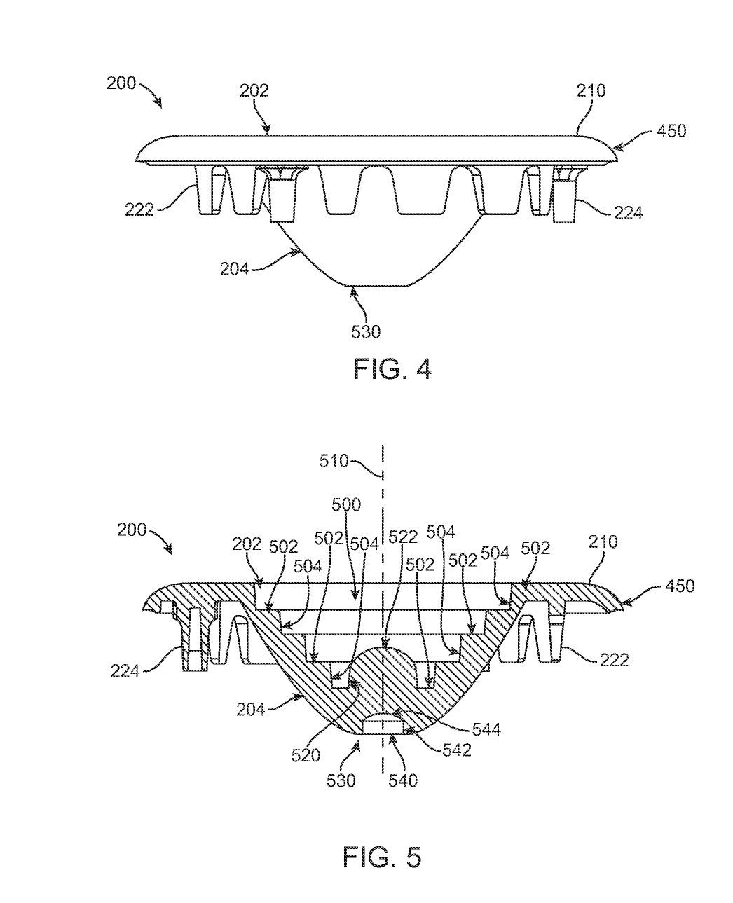

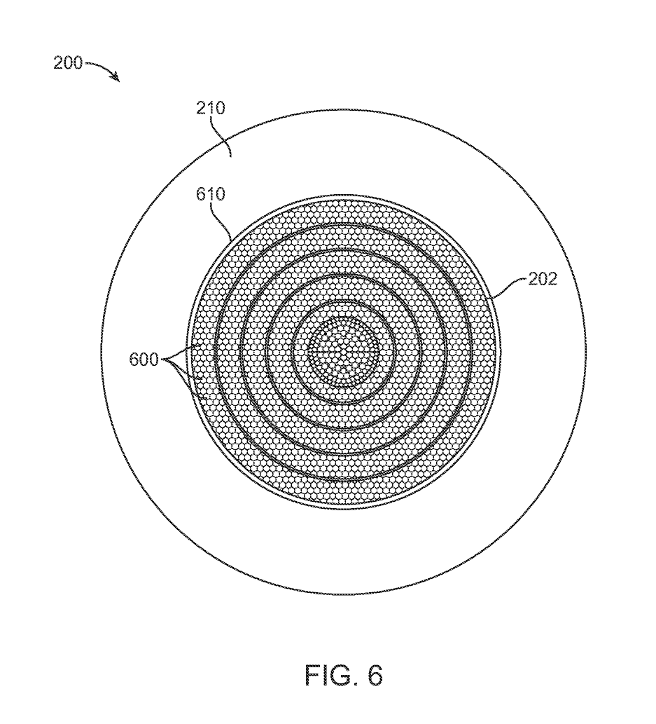

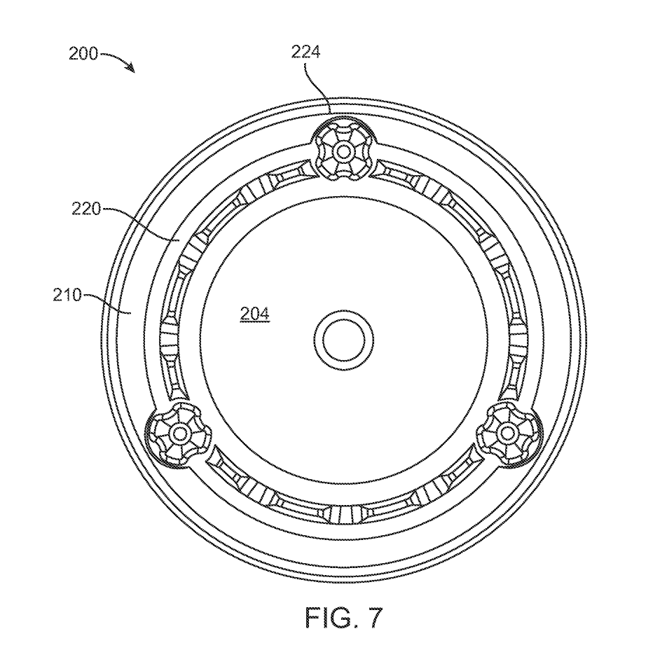

In some embodiments, a TIR lens can also include an integrated peripheral cover member extending outward from the periphery of the front surface. FIGS. 2-7 show views of a TIR lens 200 with an integrated cover member according to an embodiment of the present invention. FIG. 2 shows a front perspective view; FIG. 3 shows a back perspective view; FIG. 4 shows a side view; FIG. 5 shows a cross-section side view; FIG. 6 shows a front view; and FIG. 7 shows a back view.

TIR lens 200 can be similar or identical to TIR lens 100 in most respects, with the difference being the presence or absence of a peripheral cover member. For example, TIR lens 200 can be symmetric about an optical axis and can have a front surface 202 with a stepped shape and a convex central segment 208, as well as a back surface 204. TIR lens 200 can also include a peripheral cover member 210 that can be formed integrally with the rest of TIR lens 200. For example, TIR lens 200 can be made from a molded optically transparent material such as PMMA, other optically transparent plastics, or other optically transparent materials as desired.

Front surface 202 can have a stepped shape defining a front cavity 500, as shown in FIGS. 2 and 5. As shown in FIG. 5, the stepped shape can be defined by alternating lateral surface segments 502 and longitudinal surface segments 504. Each lateral surface segment 502 can be normal (e.g., within manufacturing tolerances) to optical axis 510. Each longitudinal surface segment 504 can be substantially parallel to optical axis 510. In some embodiments, longitudinal surface segments 504 can be parallel to optical axis 510 within manufacturing tolerances. In other embodiments, a slight inward tapering can be provided (e.g., an inward angle of approximately 1°, 2.5°, 5°, or the like relative to optical axis 510) to facilitate manufacturing, while still being considered “substantially parallel.”

The particular dimensions of lateral and longitudinal surface segments 502, 504 can be varied. In one embodiment suitable for a PAR-30 lamp replacement, the overall thickness of TIR lens 200 can be about 29.3 mm, and the diameter can be about 95.0 mm (including peripheral cover member 210). Each longitudinal surface segment 504 can define a step with a longitudinal dimension of about 5.0 mm. Each lateral surface segment 502 can have a radial width of about 4.5 mm to 5.0 mm. Within the same lens, different longitudinal surface segments 504 can have the same longitudinal dimension or different longitudinal dimensions, and different lateral surface segments 502 can have the same radial width or different radial widths. The dimensions can be optimized for a particular application based on desired optical properties of TIR lens 200, including color mixing as well as glare reduction resulting from the stepped front surface.

Convex central segment 208 can extend forward from a central lateral surface segment 502 of front surface 202. As shown in FIG. 5, convex central segment 208 can include a sidewall 520 and a convex front portion 522. Sidewall 520 can be substantially parallel to optical axis 510 (as with other longitudinal surfaces, a slight tapering can be provided to sidewall 520 to facilitate manufacturing). Convex front portion 522 can have a spherical shape (i.e., constant radius of curvature) or aspheric shape as desired. In one embodiment, sidewall 520 has a dimension along the optical axis approximately equal to the longitudinal dimension of innermost longitudinal surface segment 504. For example, convex central segment 208 can have a thickness (measured from innermost lateral surface segment 502 to the apex of convex front portion 522) of about 8.0 mm, a diameter of about 12.76 mm, and a curvature defined using an equation similar to Eq. (1) with c=0.105 and k=0. More generally, the particular shape and dimensions of convex central segment 208 can be optimized for a particular application based on desired optical properties of TIR lens 200, including reduction of a central “hot spot” (a region of extra brightness when an operating lamp is viewed directly).

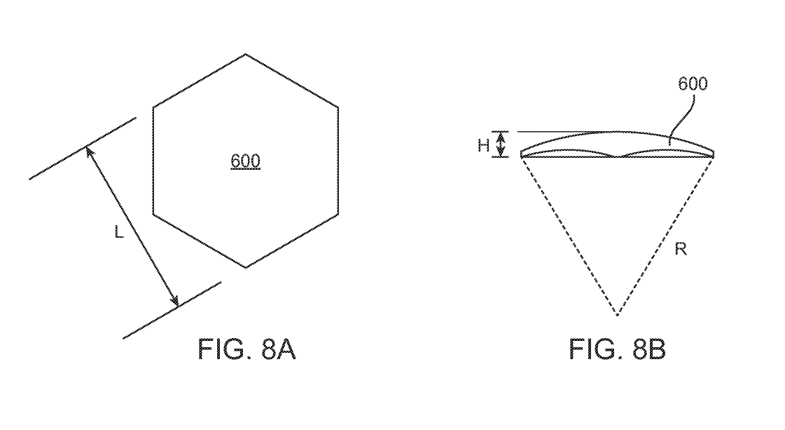

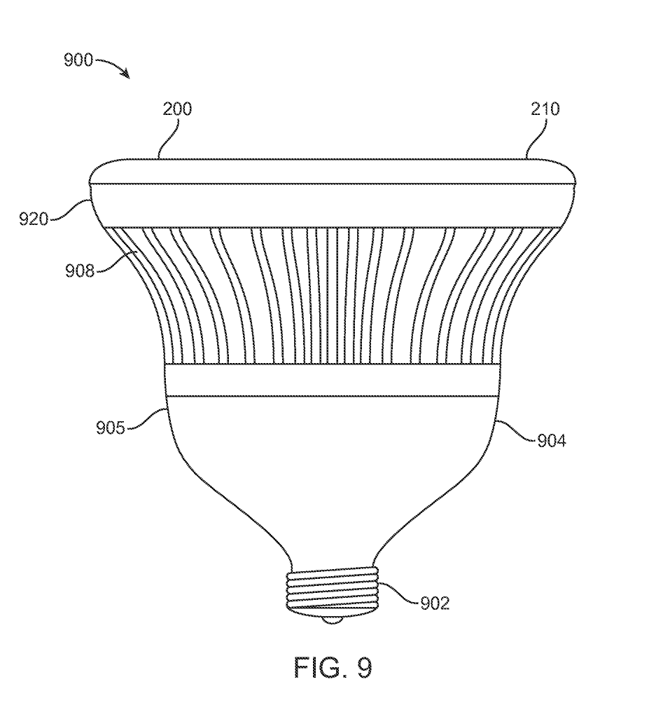

Portions (or all) of front surface 202 can be patterned with microlenses. For example, as shown in FIGS. 2 and 6, lateral surface segments 502 and convex front portion 522 of convex central segment 208 can be patterned with microlenses 600 while longitudinal surface segments 504 and sidewall 520 are not patterned. The microlenses can be, for example, small convex hexagonal structures 600 arranged on the surface as shown in FIG. 6. FIGS. 8A and 8B are, respectively, a front view and a side view of a single microlens 600. As shown in FIG. 8A, microlens 600 can be a regular hexagon with a lateral dimension L. As shown in FIG. 8B, microlens 600 can have a radius of curvature R and a height H. The parameters L, R and H can be varied to produce light beams with different beam spread characteristics. In one embodiment suitable for a PAR-30 lamp, L=1.082 mm, R=2.00 mm and H=0.10 mm. This provides a “narrow” beam spread of about 22-25° (full width at half maximum, or FWHM). Other choices of parameters will produce different beam spread. It should be noted that selection of the (R, H, L) values that govern beam shape can be largely independent of selection of any other lens parameters.

In some embodiments, portions or all of front surface 202 can be frosted in addition to or instead of being patterned with microlenses. For example, lateral surface segments 502 and convex front portion 522 of convex central segment 208 can be frosted, in addition to or instead of being patterned with microlenses. Other portions of front surface 202, such as longitudinal surface segments 504, can be unfrosted (smooth finish). Frosting of a lens surface (or portion thereof) can be achieved, e.g., by creating a texture in the corresponding surface of a mold used to form the lens. The particular texture can be varied; in one embodiment, the texture can conform to VDI 20 surface roughness specification. In some embodiments, frosting of selected lens surfaces can help to obscure from a viewer's sight any objects (e.g., lamp components) that may be present behind TIR lens 200 when TIR lens 200 is installed in a lamp.

Back surface 204 can be a smooth (unfrosted) surface shaped to provide total internal reflection of light from a light source (e.g., an emitter package containing LEDs) placed on the optical axis toward front surface 202. For example, back surface 204 can have a tapered shape as shown in FIGS. 3-5. The shape can be defined, e.g., by a conic surface equation expressed in cylindrical coordinates (r, z), where z is the longitudinal coordinate along the optical axis and r is the radial coordinate representing distance from the optical axis:

$$z = \frac{{cr}^{2}}{1 + \sqrt{1 - ( 1 + k ) {c}^{2} {r}^{2}}} \qquad ( 1 )$$

In Eq. (1), c (curvature) and k (conic constant) are parameters that can be adjusted to optimize total internal reflection and/or light output for a particular light source. In one embodiment optimized for use in a PAR-30 lamp with a multiple-LED emitter package as a light source, c=0.0072 and k=−1.051. These values may be varied for other applications. In some embodiments, the z=0 plane (the vertex of the conic described by Eq. (1)) does not coincide with back surface 204 of lens 200. For example, as shown in FIGS. 4 and 5, back surface 204 can include a flat central region 530. In one embodiment suitable for use in a PAR-30 lamp, the z=0 plane is about 2.2 mm behind flat central region 530.

As shown in FIGS. 3 and 5, TIR lens 200 can have a rear cavity 540 formed within back surface 204, e.g., within flat central region 530. Rear cavity 540 can include a cylindrical sidewall 542 and a concave central surface portion 544. Cylindrical sidewall 542 can be substantially parallel to optical axis 510; as with other longitudinal surfaces, a slight tapering can be provided to sidewall 542 to facilitate manufacturing. The radius and depth of rear cavity 540 can be chosen to optimize optical properties (e.g., color mixing and/or optical efficiency) of TIR lens 200, subject to the constraint that for any particular z within TIR lens 200, the radius of rear cavity 540 must be smaller than the radius r that satisfies Eq. (1). In one embodiment suitable for use in a PAR-30 lamp, rear cavity 540 has a radius of 8.00 mm and flat central region 530 has a radius of 11.65 mm.

Concave central surface portion 544 can be a spheric or aspheric surface as desired. The curvature can be selected to optimize the light transmission efficiency of TIR lens 200 and need not correspond to the curvature of convex surface portion 522; for example, curvature of concave central surface portion 544 can be defined using an equation similar to Eq. (1) with c=0.165 and k=0. In some embodiments, TIR lens 200 can be used with an LED emitter that has a spheric primary lens overlying the LEDs, and the spheric primary lens can extend into rear cavity 540.

The dimensions of front surface 202 and back surface 204, as well as specific surface features, can be determined based on desired optical properties of TIR lens 200 (e.g., optimizing optical efficiency and/or color mixing behavior) and the form factor of a lamp in which TIR lens 200 is intended for use. Lens thickness and diameter can also be constrained by the form factor of a particular lamp. For example, in one embodiment suitable for a PAR-30 replacement lamp (diameter of 95 mm), the diameter of front surface 202 can be about 60.0 mm, and the thickness of TIR lens 200 can be about 29.3 mm.

As shown in FIGS. 2-7, TIR lens 200 can include peripheral cover member 210 disposed at an outer peripheral region. In some embodiments, the front surface of peripheral cover member 210 can be a lateral extension of outermost lateral surface segment 502 of front surface 202. If desired, a visible feature, such as a groove 610 shown in FIG. 6, can be placed at the peripheral edge of front surface 202; however, a visible boundary marker is not required. The rear surface of peripheral cover member 210 can extend radially outward from a peripheral portion of back surface 204, e.g., as shown in FIGS. 3, 5, and 7.

In some embodiments, peripheral cover member 210 has no (or negligible) effect on the optical properties of TIR lens 200, and the dimensions of peripheral cover member 210 can be selected based on esthetic or other considerations, such as the form factor of a lamp in which TIR lens 200 is intended for use. For example, in one embodiment suitable for a PAR-30 lamp replacement, front surface 202 can have an outer diameter of 60 mm while the outer diameter of peripheral cover member 210 is about 95 mm. The longitudinal thickness of peripheral cover member 210 can also be chosen as desired. In general, peripheral cover member 210 can be thick enough to provide rigidity and strength, but thin enough that the total internal reflection provided by back surface 204 of TIR lens 200 is not adversely affected. For example, peripheral cover member 210 can be 1.5 millimeters thick. These dimensions can be varied as desired.

As shown in FIGS. 4 and 5, an outer peripheral region 450 of the front surface of peripheral cover member 210 can have a curved or tapered shape, in this case, curving away from a plane defined by outermost lateral surface segment 502 of front surface 202. In some embodiments, the curvature is provided for esthetic effect and has negligible effect on optical properties of TIR lens 200.

In some embodiments, the front surface of peripheral cover member 210 can be frosted, similarly to other portions of front surface 202. The frosting texture can be varied as desired. For instance, the front surface of peripheral cover member 210 can be frosted with a coarser texture (e.g., VDI 40 for peripheral cover member 210 and VDI 20 for frosted portions of front surface 202). Frosting of the front side of peripheral cover member 210 can help to obscure from view the back side of peripheral cover member or objects behind TIR lens 220 when viewed from the front. In some embodiments, microlenses can be formed on the front surface of peripheral cover member 210 in addition to or instead of frosting; such microlenses can provide esthetic rather effect with negligible effect on the light output.

As shown in FIGS. 3-5 and 7, the back side of peripheral cover member 210 can be shaped (e.g., by molding) to provide various retention and/or alignment structures, such as alignment tabs 222 and hollow alignment posts 224. These structures can be shaped and arranged to facilitate installation and alignment of TIR lens 200 within a lamp. It is to be understood that the retention and/or alignment structures can be modified as desired; as a result of their location, they need not affect the light output of the lens.

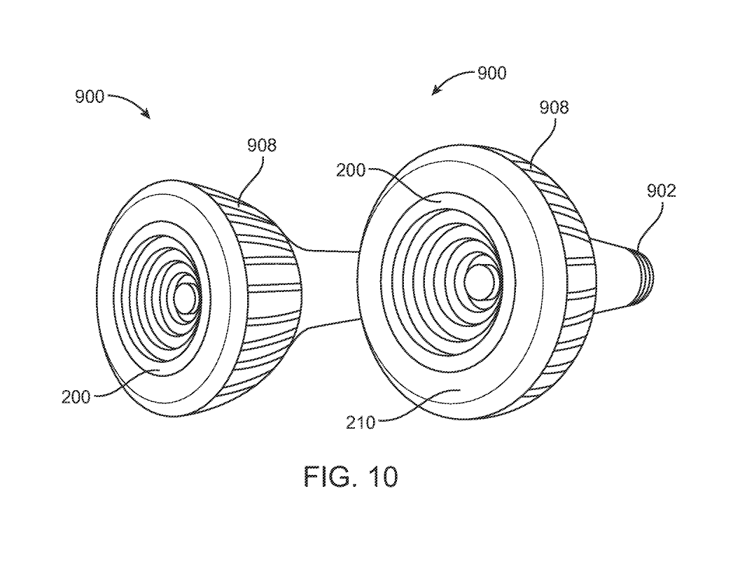

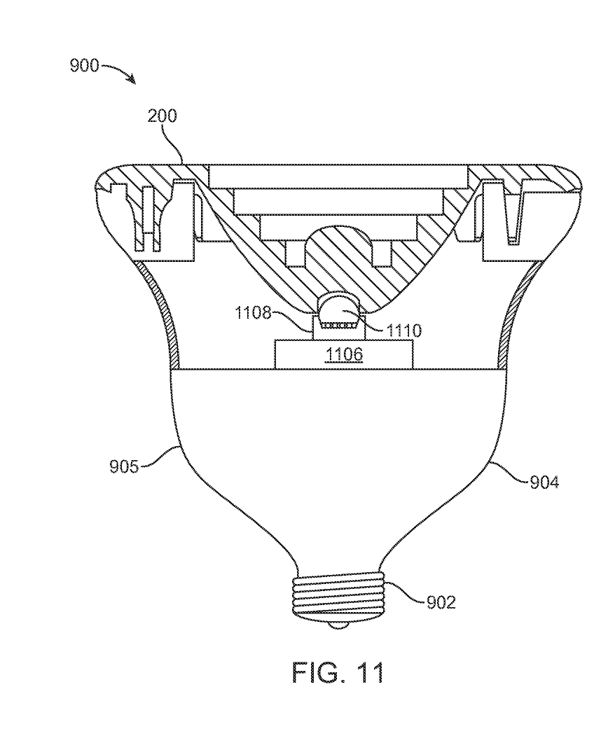

FIGS. 9 and 10 show a side view and a perspective view of a lamp 900 incorporating TIR lens 200 according to an embodiment of the present invention. FIG. 11 shows a simplified cross-sectional view of lamp 900. In this example, lamp 900 can have approximately the same form factor as a conventional PAR-30 lamp.

As shown, TIR lens 200 can cover the front face of lamp 900. When lamp 900 is installed in a light fixture, lens 200 can provide an appearance somewhat similar to conventional incandescent PAR-30 lamps.

Lamp 900 can include a screw base 902 and a frame 904. Screw base 902 can be electrically and mechanically compatible with a standard socket for a replaceable lamp. Frame 904, which can be made of aluminum or other metal or other materials, can have an outer surface 905 shaped generally similar to a conventional PAR-30 lamp. In some embodiments, frame 904 can be designed to facilitate heat dissipation and may include various openings, fins, or the like to allow for ventilation and/or weight reduction.

Frame 904 can define a platform 1106, as best seen in FIG. 11. Platform 1106 can hold a light source 1108, which can be an LED-based light source For example, light source 1108 can be an emitter package that incorporates multiple LEDs of different colors or color temperatures arranged on a single ceramic substrate, e.g., as described in U.S. Pat. No. 8,384,097; U.S. Pat. No. 8,598,793; and/or U.S. Patent App. Pub. No. 2014/0300283. Other light sources can also be used. In some embodiments, light source 1108 can include a primary lens 1110 (e.g., a spheric lens) to direct light into TIR lens 200, which can function as a secondary lens to shape the light emitted from light source 1108. For example, if light source 1108 includes multiple LEDs of different colors or color temperatures, TIR lens 200 can be shaped to provide color mixing such that the light emitted through front surface 202 has a more uniform color.

Frame 904 and platform 1106 can incorporate electrical connections (not shown) to provide power to light source 1108 from screw base 902. In some embodiments, these connections can include exposed wiring and/or components disposed on the surface of platform 1106. In some embodiments, frame 904 and platform 1106 can also incorporate control circuitry (not shown) to facilitate user control over characteristics of the light produced by light source 1108; for example, a user may be able to adjust the brightness and/or color or color temperature of emitted light.

Frame 904 can also include arms 908 that extend toward the front of lamp 900. Arms 908 can be shaped to accommodate TIR lens 200. The forward end of frame 904 can include a ring structure 920. Ring structure 920 can incorporate alignment and mounting structures, such as recesses 1110 and mounting pin structures 1112, to receive and connect to alignment tabs 222 and mounting posts 224 of TIR lens 200, thereby holding TIR lens 200 in position in relation to light source 1108 and frame 904. The particular arrangement of mounting and alignment features can be varied as desired.

In the embodiment shown, peripheral cover member 210 of TIR lens 200 extends to the outer edge of frame 904 (that is, the outer radius of TIR lens 200 is at least as large as the outer radius of frame 904 at its widest point). As a result, when lamp 900 is seen from the front, front surface 202 and peripheral cover member 210 of TIR lens 200 form the visible face of lamp 900. Microlenses and/or frosting on front-facing portions of front surface 202 and/or peripheral cover member 210 of TIR lens 200 (e.g., as described above) can disperse light such that a person looking at lamp 900 from the front would not clearly see frame 904, platform 1106, light source 1108, or any wires or other lamp components that may be disposed within lamp 900, regardless of whether lamp 900 is generating light or not. Thus, TIR lens 200 can provide the esthetic benefit of screening working structures within lamp 900 from the view of the user when lamp 900 is viewed from the front, as it would typically be when installed in a recessed or cylindrical light fixture. When lamp 900 is installed in a recessed light fixture, TIR lens 200 can also limit access to the interior region of lamp 900 and thus may help to protect light source 1108 and/or associated wiring or other components from damage.

While the invention has been described with respect to specific embodiments, one skilled in the art will recognize that numerous modifications are possible. Dimensions are provided above for example lenses and lens components solely for purposes of illustration; those skilled in the art will appreciate that dimensions can be varied as desired for a particular lamp configuration, including lamp size and the particular design of an LED emitter (or other light source) with which the lens is to be used.

A TIR lens can have a front surface shaped with a stairstep profile and a central convex region regardless of whether a peripheral cover member is also incorporated. In some embodiments, a peripheral cover member can be omitted (e.g., as shown in FIG. 1), and other mounting and/or alignment structures can be used to hold the TIR lens in place within a lamp or light fixture.

A TIR lens as described herein can provide high optical efficiency (e.g., greater than 80%) as well as desirable color mixing so that an exiting light beam produced by LEDs of disparate colors can have a uniform color across its lateral area. In addition, the shaping of the front surface can provide reduced glare and can reduce or eliminate a central hot spot. Patterning of the front surface and peripheral cover member (e.g., with microlenses and/or frosting) can provide a desirable diffusion of the light and can also serve to conceal internal lamp structures from external view as described above.

Thus, although the invention has been described with respect to specific embodiments, it will be appreciated that the invention is intended to cover all modifications and equivalents within the scope of the following claims.

What is claimed is:

1. A lens comprising:
a lens body having a back surface and a front surface,
the back surface having a tapered shape symmetric about an optical axis to provide total internal reflection to direct light from a light source position near a central portion of the back surface toward the front surface,
the front surface having a stepped shape symmetric about the optical axis, the stepped shape defining a cavity that extends into the lens body, wherein a width of the cavity increases toward a front side of the lens,
the front surface further having a convex central surface segment extending from the front surface within a central portion of the cavity.

2. The lens of claim 1 further comprising:
a peripheral cover member formed integrally with the lens body, the peripheral cover member having a front surface and a back surface,
wherein the front surface of the peripheral cover member extends laterally from an outer edge of the front surface of the lens body and the back surface of the peripheral cover member extends laterally from an outer edge of the back surface of the lens body.

3. The lens of claim 2 wherein the back surface of the peripheral cover member is shaped to include one or more alignment structures.

4. The lens of claim 3 wherein the one or more alignment structures include at least three alignment posts.

5. The lens of claim 2 wherein the peripheral cover member includes an outer portion that curves away from a plane defined by an outer portion of the front surface of the lens body.

6. The lens of claim 2 wherein the front surface of the peripheral cover member is frosted.

7. The lens of claim 6 wherein portions of the front surface of the lens body are frosted.

8. The lens of claim 1 wherein the stepped shape of the front surface includes alternating lateral and longitudinal surface segments, each lateral surface segment being normal to the optical axis and each longitudinal surface segment being substantially parallel to the optical axis.

9. The lens of claim 8 wherein the convex central portion of the front surface extends forward from a central lateral surface segment.

10. The lens of claim 9 wherein the convex central portion of the front surface includes a substantially cylindrical segment and a convex forward surface segment.

11. The lens of claim 8 wherein the lateral surface segments of the front surface are patterned with microlenses.

12. The lens of claim 1 wherein portions of the front surface, including the convex central portion, are patterned with microlenses.

13. The lens of claim 12 wherein the microlenses are convex hexagonal surface segments.

14. The lens of claim 1 wherein at least a portion of the front surface is frosted.

15. The lens of claim 1 wherein a central portion of the back surface forms a rear cavity to receive a light emitting device.

16. The lens of claim 15 wherein the back surface includes a planar portion extending around a periphery of the rear cavity.

17. The lens of claim 1 wherein the lens body is made of poly(methylmethacrylate).

18. A lamp comprising:
a light source;
a lens comprising a lens body having a back surface and a front surface,
the back surface having a tapered shape symmetric about an optical axis to provide total internal reflection to direct light from a light source position near a central portion of the back surface toward the front surface,
the front surface having a stepped shape symmetric about the optical axis, the stepped shape defining a cavity that extends into the lens body, wherein a width of the cavity increases toward a front side of the lens,
the front surface further having a convex central surface segment extending from the front surface within a central portion of the cavity; and
a frame holding the lens in alignment with the light source.

19. The lamp of claim 18 wherein the lens further comprises:
a peripheral cover member formed integrally with the lens body, the peripheral cover member having a front surface and a back surface,
wherein the front surface of the peripheral cover member extends laterally from an outer edge of the front surface of the lens body and the back surface of the peripheral cover member extends laterally from an outer edge of the back surface of the lens body.

20. The lamp of claim 19 wherein the peripheral cover member has an outer radius at least equal to an outer radius of the frame.

21. The lamp of claim 18 wherein the stepped shape of the front surface includes alternating lateral and longitudinal surface segments, each lateral surface segment being normal to the optical axis and each longitudinal surface segment being substantially parallel to the optical axis.

22. The lamp of claim 21 wherein the convex central portion of the front surface of the lens extends forward from a central lateral surface segment.

23. The lamp of claim 22 wherein the convex central portion of the front surface of the lens includes a substantially cylindrical segment and a convex forward surface segment.

24. The lamp of claim 21 wherein the lateral surface segments of the front surface of the lens are patterned with microlenses.

25. The lamp of claim 18 wherein portions of the front surface of the lens, including the convex central portion, are patterned with microlenses.

26. The lamp of claim 18 wherein the light source is an emitter with a plurality of LEDs on a single substrate.
